(19) United States
(12) Patent Application Publication
(10) Pub. No.: US 2021/0142348 A1
(43) Pub. Date: May 13, 2021

(54) MULTI-LAYERED SYSTEM FOR HETEROGENEOUS PRICING DECISIONS BY CONTINUOUSLY LEARNING MARKET AND HOTEL DYNAMICS

(71) Applicant: SOMNATH BANERJEE, SUNYVALE, CA (US)

(72) Inventor: SOMNATH BANERJEE, SUNYVALE, CA (US)

(21) Appl. No.: 17/067,742

(22) Filed: Oct. 11, 2020

Related U.S. Application Data
(60) Provisional application No. 62/913,174, filed on Oct. 10, 2019.

(51) Int. Cl. G06Q 30/02; G06F 16/25; G06N 20/20; G06N 5/00; G06Q 50/12

(52) U.S. Cl. CPC G06Q 30/0206; G06F 16/254; G06Q 50/12; G06N 5/003; G06N 20/20

(57) ABSTRACT

A computerized method for implementing multi-layered system for heterogeneous pricing decisions by continuously learning market and hotel dynamics comprising: collecting a set of data from various relevant providers, wherein the set of data comprises hotel data, competitor data, market data, and market pricing; implement extract, transform, load (ETL) operations on the set of data, wherein the ETL comprises the ingestion of the multi-textured data into Big data storage for use in an on-demand basis; implementing one or more specified data cleaning operations on the data-set(s).

### CLAIM OF PRIORITY

This application claims priority to U.S. Application No. 62/913,174, and filed on Oct. 10, 2020.

### BACKGROUND

In a data-driven world, a seemingly endless stream of dynamic data, ranging from historical trends, market fluctuations, competitor pricing to impactful events, varying air traffic and even minute factors like changing weather impact hotel demand and revenue. Unsurprisingly, determining optimal hotel prices while managing these technical complications and balancing a near limitless array of data points is impossible to do manually in a timely and cost-effective way.

### SUMMARY OF THE INVENTION

In one example, a computerized method for implementing a multi-layered system for heterogeneous pricing decisions by continuously learning market and hotel dynamics includes the step of collecting a set of data from relevant providers. The set of data from relevant providers comprises hotel data, competitor data, market data, and market pricing data. The method includes the step of implementing an ETL operation on the set of data from relevant providers. The ETL operation comprises an ingestion of the multi-textured data into a big data storage for use on an on-demand basis. The method includes the step of implementing one or more specified data cleaning operations on the dataset to generate a cleaned data set. The method includes the step of implementing one or more specified feature engineering operations on the cleaned data set. The method includes the step of generating an evaluation set and prediction set. The method includes the step of generating training and test dataset from the evaluation set. The method includes the step of building a price-sensitive demand model using the training data. The method utilizes a machine-learning gradient boosting framework and Expectation-Maximization algorithm to build the price-sensitive demand model. The method includes the step of measuring the accuracy of the model using the test data. The method includes the step of optimizing a price for a specified set of dates for a specific hotel using the prediction dataset. The method includes the step of providing a price-sensitive demand model.

### BRIEF DESCRIPTION OF THE DRAWINGS

FIG. 1 illustrates an example process for implementing a multi-layered system for heterogeneous pricing decisions by continuously learning market and hotel dynamics, according to some embodiments.

FIG. 2 illustrates an example process for division of the compiled data set, according to some embodiments.

FIG. 3 illustrates an example process for implementation of the EM algorithm, according to some embodiments.

FIG. 4 illustrates an example process for optimization of sell rates for all future stay dates, according to some embodiments.

FIG. 5 depicts an exemplary computing system that can be configured to perform any one of the processes provided herein.

The Figures described above are a representative set, and are not exhaustive with respect to embodying the invention.

### DESCRIPTION

Disclosed are a system, method, and article of a multi-layered system for heterogeneous pricing decisions by continuously learning market and hotel dynamics. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to “one embodiment,” “an embodiment,” ‘one example,’ or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### DEFINITIONS

Example definitions for some embodiments are now provided.

Application programming interface (API) can specify how softwaremponents of various systems interact with each other.

100181 Average daily rate (ADR) is a lodging industry statistic. In one example, ADR represents the average price or rate for each hotel room sold for a specific day.

Big data is a field that treats ways to analyze, systematically extract information from, or otherwise deal with data sets that are too large or complex to be dealt with by traditional data-processing application software. In one example embodiments, Big data information can include the following: one Billion plus of reservations records at a hotel level which accounts for more than two hundred Gigabytes (GB); twenty-nine Million plus of sell rate records at hotel level which accounts for more than 1 Gigabyte (GB); eighty-eight Million plus of sell rate records at a competitive set level which accounts for more than 2 Gigabytes (GB); seven hundred Million plus of reservation records at a market level which in physical storage space accounts for more than one hundred eighty Gigabytes (GB); thirty-eight Million plus sell rate records at a market level which in physical storage space accounts for more than two Gigabytes (GB); one hundred Million plus of forecast records at a market level which in physical storage space accounts for more than eighty Gigabytes (GB); and two hundred seventy-five Million plus records of flights, events, and weather data which in physical storage space accounts for more than two hundred fifty Gigabytes.

Cloud computing is the on-demand availability of computer system resources, especially data storage (e.g. cloud storage) and computing power, without direct active management by the user. The term is generally used to describe data centers available to many users over the Internet. Large clouds, predominant today, often have functions distributed over multiple locations from central servers.

Competitive Set (e.g. a competitor set) is a group of hotels that are seen as direct competitors to a specified hotel. The hotel can compare its metrics against the set of competitor hotels.

Extract, transform, load (ETL) is the general procedure of copying data from one or more sources into a destination system which represents the data differently from the source(s) or in a different context than the source(s).

Data cleaning is the process of detecting and correcting (and/or removing) corrupt or inaccurate records from a record set, table, or database and refers to identifying incomplete, inaccurate, or irrelevant parts of the data and then replacing, modifying, or deleting the dirty or coarse data. Data cleansing may be performed interactively with data wrangling tools, or as batch processing through scripting.

Expectation-maximization (EM) algorithm is an iterative method for finding maximum likelihood or maximum a posteriori estimates of parameters in statistical models. The EM model can use unobserved latent variables as well. The EM iteration can alternate between performing an expectation step. The expectation step can create a function for the expectation of the log-likelihood evaluated using the current estimate for the parameters, and a maximization step. The maximization step computes parameters maximizing the expected log-likelihood found on the expectation step. These parameter-estimates are then used to determine the distribution of the latent variables in the next expectation step.

Gradient boosting is a machine learning technique for regression and classification problems, which produces a prediction model in the form of an ensemble of weak prediction models (e.g. decision trees). Gradient boosting builds the model in a stage-wise fashion like other boosting methods do, and it generalizes them by allowing optimization of an arbitrary differentiable loss function.

Occupancy is a lodging industry statistic. In one example, Occupancy represents the percentage of rooms occupied based on a hotel's capacity.

RevPAR (revenue per available room) is a performance metric for hotels. It can be used to assess how well a hotel has managed its inventory and rates to optimize revenue. It can be calculated by multiplying occupancy by ADR.

On the books is a measure used when looking ahead to see how occupancy or revenue is booked in a hotel. The amount that is on the books will change as more reservations and cancellations occur until the date or period is arrived at, so it is a measure of a moment in time.

Sell rate can be simply defined as the amount the guest has to pay for a hotel's room night.

Willingness to pay (WTP) is the maximum price at or below which a consumer will purchase one unit of a product. This corresponds to the standard economic view of a consumer reservation price.

Price sensitivity measures how the hotel's sell rate affects demand, and vice versa. Price-sensitive demand model (price recommender) is a model that gauges the change in demand for hotel inventory with respect to changes in a hotel's sell rate.

Gradient boosting framework is a machine learning framework where weak learners are trained in a gradual, additive, and sequential manner. This method fits the new predictor of the residual errors made by the previous predictor for every incorrect observation at every iteration.

Recommended sell rate is a sell rate generated from the price-sensitive demand model that will provide the maximum revenue for the hotel. That is accomplished by doing an optimization at price point (or optimal price) that determines the best mix between pricing and demand. This optimal price (or optimal price) is the amount any guest has to pay for a hotel room for that particular night.

Decision trees are constructed via an algorithmic approach that identifies ways to split a data set based on different conditions. The goal is to create a model that predicts the value of a target variable by learning simple decision rules inferred from the data features by minimizing the generalization error.

Training data set is a composition of different data sources containing values of both independent variables and target variables. This data set is used to build the price-sensitive demand model. Evaluation data set is derived from the same data sources in training data set but is kept aside from model training phase and used to evaluate the price-sensitive demand model's performance. The performance metric (error) is measured as the difference between the target value and the value predicted by the model. Test data set is derived from the same data sources but contains new samples and used to recommend sell rates to the hotel. Data sources include, inter alia: hotel reservations data, market reservations, competitor sell rates, events, weather, and market sell rates.

### EXAMPLE METHODS

Example methods can recommend real-time prices for heterogeneous objectives. Heterogeneous objectives can include, inter alia: maximization of revenue and/or optimal rooms pickup, improving quality, customer satisfaction and market penetration (e.g. leveraging market penetration indices). This is achieved by using a combination of machine learning and Expectation-Maximization algorithm to have good predictive power as well as the underlying data distribution.

FIG. 1 illustrates an example process 100 for implementing a multi-layered system for heterogeneous pricing decisions by continuously learning market and hotel dynamics, according to some embodiments. The pricing system starts with fetching hotel reservations data and historical hotel sell rate data in step 102. In addition to hotel reservations data, other data sources like market reservations, competitor sell rates, events, weather, market sell rates etc. (e.g. optional but preferred) are collected for generation of more robust pricing. In step 104, process 100 implements Big data ETL, which includes the ingestion of the multi-textured data (e.g. outlined in step 100) into Big Data storage for use on demand basis, step 106. In step 108, data retrieval can be implemented which includes obtaining data from a database storage system. In step 110, data cleansing can be implemented on the output of step 108. This can include, inter alia, data curation which is modifying the data to ensure that it is free of irrelevances and incorrect information. In step 112, feature engineering steps can be implemented which includes data transformation and feature extraction. In step 114, features can be created. This involves applying domain expertise and creating new features that help derive new insights from the original data source.

It is noted that features can include on-the-books hotel reservations (e.g. rooms sold, ADR, RevPAR, revenue), seasonality (e.g. day of the week, month of year, seasonal demand) and lead time (e.g. Days Before Arrival (DBA)). Seasonality is the presence of consumer behavior that occurs at specific regular intervals. Days before arrival is defined as the time difference between when the customer books a reservation at a hotel and the arrival date of the customer. DBA is grouped in specified bins (e.g. ‘buckets’) as a categorical variable rather than using DBA itself as a quantitative variable. In addition to hotel reservations data, market reservations data (e.g. optional data source) can also be used to highlight how patterns in the market can impact hotels. Market reservations data includes Occupancy, ADR, and RevPAR on the market. Depending on which market a hotel is located in, the market can have varying levels of impact on a hotel's demand and pricing strength. Sets of sell rates of competitor hotels (e.g. optional data source) are also collected for the pricing system. This has a strong impact on how the hotel prices their inventory and maintains competition for attracting potential customers. More on these specific factors are stated, infra. Other data sources (e.g that are optional data sources) might include flights data, events data, weather data and market level sell rates data.

In Step 116, a booking curve model is formed for a hotel's inventory. This booking curve illustrates the rate at which a hotel's inventory is bought by customers. Additionally, the curve can determine the critical mass of bookings during specific lead time windows. The booking curve is formed by finding the median on the booking occupancy for each day in the lead time. The model then normalizes the total demand by forming an exponential function of the typical booking curve first and then using a simple ordinary least squares model to determine the booking curve ratio. The booking curve ratio is a parameter of the exponential model that defines the rate at which rooms are picked up. Demand to come is defined as the number of potential customers for a given stay date who may book in the future, not counting those customers who have already booked or decided not to book in the past. Thus, the normalized demand is estimated by dividing demand-to-come with booking curve ratio. It should be noted that since occupancy cannot exceed hotel capacity, the booking curve is therefore constrained not to exceed one-hundred percent (100%) occupancy. The demand is normalized as such to control for typical booking pace so that the model for demand will not see such spurious relationships.

In step 118, willingness to pay (WTP) is modeled as a distribution of the random variable W, which is defined as the maximum price a given customer is willing to pay. W may be modeled by the price the hotel charges. For example, a distribution is fit to the WTP variable which is based on either the current sell rate of the hotel room or how much the ADR has picked up for the room. The sell rate is the rate at which the hotel sets the “BAR” (Best Available Rate) to sell a room for a given stay date. ADR pickup is defined as how much ADR is picked up from the current value to the value that is recorded after the date of arrival for the stay date. The willingness to pay (WTP) will vary across different categories. A WTP category can be any of the categorical variables such as dba-bucket, month, day-of-the-week, overall, season, market demand category. With the WTP categories evaluated, a WTP category is assigned to each data point in the training data. Thereafter, ‘n’ distributions are fit based on the ‘n’ different categories seen in the data, depending on the WTP category described above. Multiple different distributions can be used (e.g. truncated) normal distribution or Log-normal distribution or Cauchy distribution or Pareto distribution.

In step 120, competitor sell-rate adjustments can be implemented. Competitor sell-rate adjustment is a normalization process done on the historical competitors' sell rates. Historically competitors could have priced significantly higher than the hotel. However, this does not mean the hotel's sell-rate should always be adjusted upward. The normalization process addresses this issue and scales the competitor's sell rates to the same scale as the hotel in context. Relative changes in the sell rates are then considered rather than absolute sell-rate changes. For each hotel in the competitor set, the historical sell rates are used to create a linear model where the sell-rate of the competitor is a function of the hotel's sell-rate. The coefficients of the linear model are the normalized competitive set ratios. The competitor sell-rate adjustments can then be applied.

In step 122, feature selection can be implemented. Based on availability of the data sources (for example, hotel reservations data, hotel sell rates, market reservations, competitor sell rates, events, weather, market forecast), features are selected. Thereafter, data transformation of features is also performed. In step 122, key features are extracted which significantly improve the learning algorithm's performance.

FIG. 2 illustrates an example process for division of the compiled data set, according to some embodiments. The process details the division of the compiled data set 200. In one example of process 200, the data set is split into two different sets, e.g. evaluation set 202 and prediction set 208. Process 300 (as stated infra) builds the price-sensitive demand model, using the evaluation set from process 200. The evaluation set is split into a training set 204 and testing set 206. The parameters of the demand are determined using the Expectation-Maximization algorithm on the training set 204 and the process is stated infra. The prediction set is then used to generate recommendations for future arrival dates.

FIG. 3 illustrates an example process 300 for implementation of the EM algorithm, according to some embodiments. Process 300 describes the implementation of the EM algorithm. In step 302, the EM algorithm can be used to find maximum-likelihood estimates for the demand model and willingness-to-pay parameters. In step 304, a demand variable is assigned to each data point seen in the training data. The demand variable is assigned by finding the probability a customer would be willing to stay based on the available rooms in the hotel and given the hotel's sell rate. The demand variable is used to compute the normalized demand in the booking curve model in step 116, supra. Rooms pickup can be defined as the difference of the number of rooms as of current date and the number of rooms that are sold after the date of arrival for the stay date. In step 306, the EM algorithm is initialized. In step 308, the demand (e.g. re-normalized) is modeled using a Machine Learning predictive model such as LightGBM as described infra based on the feature set (e.g. feature vectors) selected in step 122. The EM algorithm determines the values of the parameter beta in the model for demand given the feature set selected in step 122. The objective of the EM algorithm here is to choose the demand model parameter beta by maximizing the log-likelihood of the probability of the number of rooms picked up given the demand and the parameters. In step 310, after the beta parameter is estimated, the probability of the rooms picked up are calculated again and the total log-likelihood is computed. In step 312, the process supra is repeated until the maximum likelihood of the probability of rooms picked up is achieved and the beta parameter is determined.

In one example, machine learning algorithm LightGBM can be implemented. The LightGBM is a gradient boosting decision tree algorithm. The idea behind ‘boosting’ in machine learning is to train weak learners in a gradual, additive, and sequential manner, each trying to improve over its prior learner. This method fits the new predictor of the residual errors made by the previous predictor for every incorrect observation at every iteration. The LightGBM can handle larger data sets without trading off between both efficiency and accuracy.

A model for total rooms (total sold rooms for a given stay date) as a function of price and other features is created, that is, we have a price-sensitive forecast. The demand model is:

Forecasted rooms(feature vectors, price)=min(capacity, expected rooms*P(W>price)

where, feature vectorsare the features that have impact on forecasted roans; capacity is the capacity of the hotel; expected rooms is the demand computed in the EM algorithm described in process 300; P(W>Price)is the probability of WTP being greater than price. This helps in evaluating the accuracy of the model using the test set from process 200.

In step 126, the sell rates recommendations are achieved based on the hotel demand.

FIG. 4 illustrates an example process 400 for optimization of sell rates for all future stay dates, according to some embodiments. Process 400 describes the optimization of sell rates for all future stay dates. In step 402 the prediction data set is gathered from process 200 supra. In step 404, the willingness-to-pay distribution is adjusted based on (e.g. re-normalized) comp-set sell rates from Step 120. The maximum a-posteriori estimate for the mean of the WTP curve is estimated based on the observed (e.g. re-normalized) comp-set sell rates. The result is a WTP curve which makes the observed comp-set prices more likely. In step 406, the forecasted demand for any arrival date in the future is adjusted by the comp-set sell rates. This accounts for the impact the competitive set's pricing has on the hotel's demand. To adjust the demand, an assumption is made that the competitors hotel's are the same as the current hotel. The competitors' capacity is assumed to be the same as the current hotel's capacity. The on-the-books rooms of the competitors are the same as the current hotel. Thereafter, with the information supra and competitors' sell rates, the demand is forecasted for each competitor. In step 408, recommended rates are chosen by taking the price to optimize the expected revenue for the property:

Revenue=min(demand X P(W>Price), max pickup)X Price

where max pickup is the maximum number of rooms that can be sold from the current date until the date of arrival for a stay date. In step 410, pricing controls can be used on the optimized sell-rates based on the hotel's rules and regulations.

In step 412, the optimized sell-rates are written to the database according to some embodiments.

Process 100 can be utilized as follows. Process 100 enables a paradigm shift away from rigid traditional revenue management systems by implementing dynamic pricing based on multitude of data sources (e.g. historical hotel sell rates, competitor sell rates, market dynamics, events, holidays, weather data). Process 100 can recommend price for heterogeneous objectives like maximum revenue and optimal rooms pickup. Process 100 can interact with the following systems, inter alia: Property Management Systems (PMS) to source past and future reservations data; Central Reservation Systems (CRS) to source current sell rates and push recommended rates; Customer Relationship Systems (CRM) to integrate customer profile and satisfaction; Channel Management Systems (CM) to balance business across channels; Guest Review Systems to source text-based guest reviews; etc.

Moreover, this system is designed and built as a generic framework with reusable objects like products (e.g. rooms for hotel industry), product-types (e.g. room-types for hotel industry) , demand, price, and business rules (e.g. accessible room types will have to the same price as their corresponding room types). This framework can easily be extended in setting prices to other business domains by collection of domain specific data and requirements.

### Additional Exemplary Systems

FIG. 5 depicts an exemplary computing system 500 that can be configured to perform any one of the processes provided herein. In this context, computing system 500 may include, for example, a processor, memory, storage, and I/O devices (e.g., monitor, keyboard, disk drive, Internet connection, etc.). However, computing system 500 may include circuitry or other specialized hardware for carrying out some or all aspects of the processes. In some operational settings, computing system 500 may be configured as a system that includes one or more units, each of which is configured to carry out some aspects of the processes either in software, hardware, or some combination thereof.

FIG. 5 depicts computing system 500 with a number of components that may be used to perform any of the processes described herein. The main system 502 includes a motherboard 504 having an I/O section 506, one or more central processing units (CPU) 508, and a memory section 510, which may have a flash memory card 512 related to it. The I/O section 506 can be connected to a display 514, a keyboard and/or other user input (not shown), a disk storage unit 516, and a media drive unit 518. The media drive unit 618 can read/write a computer-readable medium 620, which can contain programs 622 and/or data. Computing system 600 can include a web browser. Moreover, it is noted that computing system 600 can be configured to include additional systems in order to fulfill various functionalities. Computing system 600 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

In one example, a computerized method for implementing a multi-layered system for heterogeneous pricing decisions by continuously learning market and hotel dynamics includes the step of collecting a set of data from relevant providers. The set of data from relevant providers comprises hotel data, competitor data, market data, and market pricing data. The method includes the step of implementing an ETL operation on the set of data from relevant providers. The ETL operation comprises an ingestion of the multi-textured data into a big data storage for use on an on-demand basis. The method includes the step of implementing one or more specified data cleaning operations on the dataset to generate a cleaned data set. The method includes the step of implementing one or more specified feature engineering operations on the cleaned data set. The method includes the step of generating an evaluation set and prediction set. The method includes the step of generating training and test dataset from the evaluation set. The method includes the step of building a price-sensitive demand model using the training data. The method utilizes a machine-learning gradient boosting framework and Expectation-Maximization algorithm to build the price-sensitive demand model. The method includes the step of measuring the accuracy of the model using the test data. The method includes the step of optimizing a price for a specified set of dates for a specific hotel using the prediction dataset. The method includes the step of providing a price-sensitive demand model.

### Conclusion

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A computerized method for implementing a multi-layered system for heterogeneous pricing decisions by continuously learning a market dynamic and a hotel dynamic comprising:
collecting a set of data from a set of relevant providers, wherein the set of data from the set of relevant providers comprises a hotel data, a competitor data, a market data, and a market pricing;
implementing an extract, transform, load (ETL) operation on the set of data from the set of relevant providers, wherein the ETL operation comprises an ingestion of a multi-textured data into a big data storage for use on an on-demand basis;
implementing one or more specified data cleaning operations on the set of data from the set of relevant providers to generate a cleaned data set;
implementing one or more specified feature engineering operations on the cleaned data set;
generating a training data set;
generating an evaluation data set;
generating a test data set;
building a price-sensitive demand model using the training data;
with the price-sensitive demand model, generating a prediction data set;
with the prediction data set, optimizing a price for a specified set of dates for a specific hotel; and
providing a price-sensitive demand model, wherein the price recommender utilizes a machine-learning gradient boosting framework and Expectation-Maximization algorithm to build the price-sensitive demand model.

2. The computerized method of claim 1, wherein the hotel data comprises a set of hotel reservations data.

3. The computerized method of claim 2, wherein the hotel data comprises a set of market level reservations data.

4. The computerized method of claim 3, wherein the hotel data comprises a set of hotel sell rates data.

5. The computerized method of claim 4, wherein the hotel data comprises a set of competitor hotel's sell rates data.

6. The computerized method of claim 5, wherein the hotel data comprises a set of market level pricing data.

7. The computerized method of claim 6, wherein the one or more specified data cleaning operations on the set of data from the set of relevant providers comprises an imputation operation on a set of missing data and a removal of erroneous values and outliers.

8. The computerized method of claim 7, wherein the one or more specified feature engineering operations on the cleaned data set comprises applying a domain knowledge enabled operation on the cleaned data set and creating one or more specified features that are used to derive an insight from an original data source, wherein the original data sources comprises a hotel reservations data, a market reservations data, a competitor sell rates data, an events data, a weather data and a market sell rates data.

9. The computerized method of claim 1, wherein the hotel training set comprises information on historical occupancy data, from the set of relevant providers data, RevPAR data, hotel pricing data, competitor set pricing data, market occupancy data, market an Average daily rate (ADR) data, a market RevPAR (revenue per available room) data, an optional events and a seasonality factor data.

10. The computerized method of claim 9, wherein the seasonality factor data comprises a demand on a weekly, a demand on a monthly, a demand on a quarterly level, and a lead time/Days Before Arrival of an arrival date.

11. The computerized method of claim 10, wherein a set of parameters of the price-sensitive demand model are determined using an expectation-maximization algorithm with one or more machine learning algorithms that are structured optimally to overcome an overfitting or an underfitting for a learning process.

12. The computerized method of claim 11, wherein the specified set of forecasted demand comprises a forecasted rooms sold data set.

13. The computerized method of claim 12, wherein the specified set of optimized rates comprises a recommended sell rate.

14. The computerized method of claim 1, wherein only hotel reservations and hotel sell-rates are required to recommend sell rates while other data sources are optional, wherein as data streams are ingested into the system on an iterative process, the price-sensitive model is continuously re-trained.

15. The computerized method of claim 1, wherein the machine-learning gradient boosting framework implements a tree-based learning algorithm to build the price-sensitive demand model.

16. The computerized method of claim 1, wherein the optimized revenue value is calculated by using a forecasted rooms sold value and an optimized sell rate .

17. The computerized method of claim 1, wherein the sell rate objective of a hotel is interchangeable from maximizing revenue to maximizing the occupancy of the hotel.
